(19) United States
(12) Patent Application Publication
(10) Pub. No.: US 2008/0073883 A1
(43) Pub. Date: Mar. 27, 2008

(54) Holding element and side-impact airbag module

(75) Inventors: Anton Fischer, Leinweiler (DE); Juergen Heigl, (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/897,162

(22) Filed: Aug. 29, 2007

(30) Foreign Application Priority Data
Sep. 26, 2006 (DE) 10 2006 045 245.3

(51) Int. Cl. B60R 21/217; B60R 21/26

(52) U.S. Cl. 280/728.2; 280/741

(57) ABSTRACT

A holding element that fastens a gas generator in an airbag module has a rigid, elongated base as well as at least one fastening section that allows the holding element to be fastened to a vehicle-fixed part perpendicular to the lengthwise direction of the base.

### FIELD OF THE INVENTION

The invention relates to a holding element that fastens a gas generator in an airbag module. Further, the invention relates to an airbag module, especially with a holding element.

### BACKGROUND OF THE INVENTION

When an airbag module is activated, a gas-generating propellant charge is ignited inside the gas generator. As a result, the gas needed to fill the airbag is released abruptly. The gas can only exit from the gas generator through relatively small, predetermined outflow areas so that, in view of the recoil principle, considerable forces are exerted on the gas generator. If the outflow areas are distributed in such a way that the total momentum of the gas generator is zero, one speaks of a thrust-neutral gas generator. However, it is often the case that sections of the outflow areas of the gas generator are covered or closed, for example, in order to protect an airbag against exposure to heat. This results in a certain net momentum of the gas generator or of the entire airbag module.

When an airbag module is installed in a vehicle, this net momentum is often taken up by a holding element by means of which the gas generator is fastened in the vehicle. Usually, such a holding element also has to absorb the forces of the unfolding airbag since the airbag is likewise fastened to the holding element.

The trend, particularly with side-impact airbag modules that are installed in the region of the roof frame, is to do without a module housing surrounding the folded airbag and the gas generator to the extent possible. This has proven to be feasible since, in fact, the airbag module is already quite well-protected against external influences by virtue of its position behind the interior cladding of the vehicle.

### BRIEF SUMMARY OF THE INVENTION

It is an object of the invention to configure a holding element for an airbag module with sufficient stability and so that it takes as little space and can be manufactured as easily as possible.

For this purpose, a holding element that fastens a gas generator in an airbag module has a rigid, elongated base and at least one fastening section that allows the holding element to be fastened to a vehicle-fixed part perpendicular to the lengthwise direction of the base. The base has, in particular, a flat shape. The elongated configuration allows a secure fastening of the airbag and of the gas generator as well as an easy dimensioning with respect to length to fit various types of airbag modules and vehicles.

The holding element may consist of only the base and the fastening section(s), which has the advantage of very low manufacturing costs. It may even be reduced essentially to a flat rod with fastening capabilities.

Another advantage can be achieved if the fastening section, seen in the lengthwise direction of the base, can be fitted with fastening means from opposite sides of the base. After all, in this case, an identical holding element can be used for installation on the driver's side as well as on the passenger's side of a vehicle. Consequently, there is no longer a need to produce and stock two different parts.

Preferably, the holding element is configured so as to be essentially mirror-symmetrical relative to the lengthwise direction of the base. Of course, the symmetry only has to be observed to such an extent that the holding element can be easily fastened to both sides of the vehicle.

The fastening section can be, for example, an end section of the base that is bent to form an eyelet. In this case, the holding element is configured entirely in one piece. Then, all that is needed is a shaping step but not, for instance, welding of a fastening eyelet to the base.

Preferably, two fastening sections are provided that are arranged, for example, on opposite ends of the base.

The base may have an opening for fastening a gas generator. This is the easiest conceivable way to join a gas generator to the holding element. A fastening element, for example, a screw bolt, joined to the gas generator, or else a screw connected to a clamp surrounding the gas generator, can be inserted through the opening in the base and secured with a nut.

Moreover, the base may have an indentation, for example, for holding a clamp to secure the gas generator.

A fastening means for a holding bracket that partially surrounds the gas generator can also be provided on the base. When the generator is firmly joined to the holding element at one end, it is sufficient to secure it to the holding element with a clamp or a holding bracket at the other end. Moreover, the clamp or the holding bracket can be used to seal off an insertion opening of the airbag. In addition, when a combination of a fastening means and a holding bracket is used, the assembly work is reduced since part of the fastening means is already integrated into the holding element.

Further, it is an object of the invention to provide a simple and cost-effective airbag module.

This is achieved in an airbag module, especially with a holding element of the type described above, where preference is given to providing an elongated gas generator that is arranged at least partially inside the airbag.

The gas generator can be surrounded at least in sections by a gas baffle plate. Gas baffle plates are used to divide the gas flow into the airbag and to systematically guide gas into individual inflatable chambers of an airbag. Moreover, such a gas baffle plate may protect the wall of the airbag from gas flowing directly out of the gas generator.

In a preferred embodiment of the invention, the gas baffle plate is formed of one single blank that can be spread out flat and that is then bent to form the gas baffle plate.

The gas baffle plate is preferably made of metal but it could also be a part made of a suitable plastic having the above described form.

Preferably, the gas baffle plate is bent in such a way that two end sections of the gas baffle plate overlap. Hence, the gas baffle plate forms a tube that surrounds the gas generator. It is possible and desirable for certain sections of the outflow area of the gas generator to be covered and closed by the gas baffle plate. The gas baffle plate can lie directly against the outer wall of the gas generator.

In this case, the gas generator or the airbag module is not necessarily thrust-neutral, which is not actually necessary when the gas bag module is in the installed state in the vehicle, since the resulting momentum of the gas generator is absorbed by the vehicle via the fastening means of the gas generator.

However, in Germany, the Federal Institute for Materials Research and Testing (BAM) requires thrust-neutrality for airbag modules (that have not yet been installed in the vehicle). Here, the so-called bonfire test is carried out in which the entire airbag module is exposed for a prolonged period of time to an elevated ambient temperature (in the range of 160° C. [320° F.]), so as to simulate a vehicle fire.

When the airbag module is in the installed state in the vehicle, the gas baffle plate is preferably arranged in the immediate vicinity of a vehicle-fixed part, for example, a section of the car body, in such a way that the gas baffle plate is supported on the vehicle-fixed part when the airbag module is activated.

The gas flows coming from the gas generator strive to push the end sections of the gas baffle plate away from each other. If the gas baffle plate, especially the radially outwards lying of the two end sections, can be supported on a vehicle-fixed part, a counterforce is available and the gas baffle plate remains rolled together like a tube so that the gas is guided in the intended directions.

In addition or as an alternative to the support on the car body, the airbag can have a partition whose dimensions are selected in such a way that the gas baffle plate is supported on the partition during normal activation of the airbag module. The expression “normal activation” means the activation in the installed state during which, at normal ambient temperatures of about −40° C. [−40° F.] to +80° C. [176° F.], the gas-generating material in the gas generator is ignited in response to a sensor signal. The partition in the airbag may be, for example, a seam or a dart that forms a constriction at which the diameter of the airbag is so small that the gas baffle plate cannot unroll due to the force exerted by the outflowing gas.

In contrast, during an activation of the airbag module when it is not installed in a vehicle, it is advantageous for the pressure of the gas coming from the gas generator to push the overlapping end sections away from each other. Here, for example, the supporting effect on a vehicle-fixed part is absent. As a result, when the gas generator is ignited in the uninstalled state, the gas baffle plate unrolls and releases the previously covered sections of the outflow area. Hence, the thrust-neutrality is at least largely restored and the net momentum of the airbag module is reduced or completely eliminated.

If the activation is carried out under the conditions of a bonfire test, the fabric of the airbag softens or breaks down as a result of the high ambient temperature, and any partition in the airbag that might be present opens or is destroyed so that this partition does not offer any resistance to the gas baffle plate. Therefore, the gas baffle plate can unroll when it is struck by the gas flow, as a result of which the thrust-neutrality of the airbag module is restored.

According to another embodiment, a gas-distributing tube that surrounds the gas generator is provided with a fastening opening via which the gas-distributing tube is fastened to the holding element, said holding element being adapted in the area of the fastening opening to the curvature of the gas generator, so that the gas-distributing tube is sealed off vis-à-vis the holding element. The gas-distributing tube is advantageously positioned between the outer wall of the gas generator and the holding element. In this manner, with very little effort, it is possible to dispense with complicated sealing means between the gas-distributing tube and the holding element.

Preferably, the gas-distributing tube is fastened by means of the opening for fastening the gas generator to the holding element.

The holding element may have at least one bead facing the gas generator and running around the opening for fastening the gas generator by which bead the adaptation to the shape of the gas generator as well as the sealing function is achieved.

Preferably, the gas generator has a radially projecting fastening bolt that protrudes through the fastening opening in the gas-distributing tube or in the gas-guiding element and through the opening for fastening the gas generator in the holding element.

### SHORT DESCRIPTION OF THE DRAWINGS

FIG. 1 shows an airbag module according to the invention in a first embodiment;

FIG. 2 shows the airbag module of FIG. 1, depicting only the holding element, the gas generator and a gas baffle plate;

FIG. 3 shows the airbag module of FIG. 2 with the unrolled gas baffle plate;

FIG. 4 shows the airbag module of FIG. 3 as seen from the bottom;

FIG. 5 shows a schematic sectional view of the airbag module with a gas baffle plate, provided in the vehicle as an occupant restraint system;

FIG. 6 shows an airbag module according to the invention in a second embodiment with a gas-distributing tube;

FIG. 7 shows a schematic view of an airbag module according to the invention in a third embodiment with a gas-distributing tube;

FIG. 8 shows the airbag module of FIG. 7 in a reduced view;

FIG. 9 shows a perspective view of the holding element, the gas generator and the gas-distributing tube of the airbag module of FIG. 7;

FIGS. 10 and 11 each show a schematic perspective view of the airbag module of FIG. 7, in which the gas-distributing tube has been left out for the sake of clarity; and

FIGS. 12 to 14 show views of a fourth embodiment of an airbag module according to the invention.

### DETAILED DESCRIPTION OF PREFERRED EMBODIMENTS

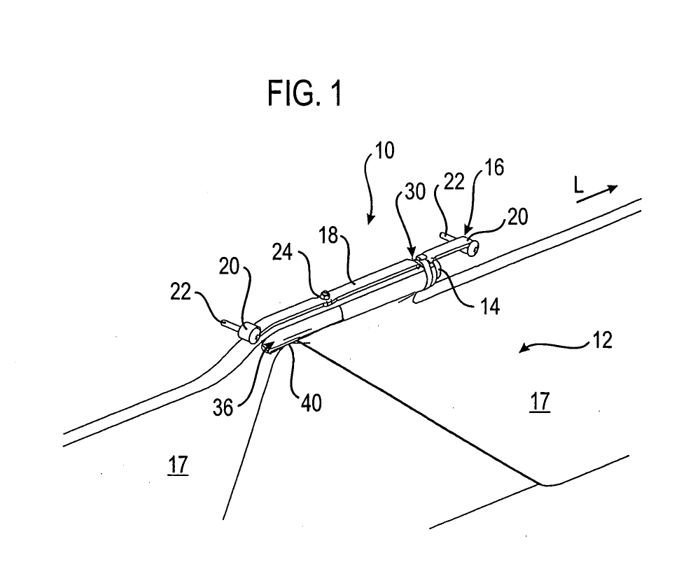

FIG. 1 shows an airbag module 10 as part of a vehicle occupant restraint system comprising an airbag 12 shown in the unfolded state, a gas generator 14—here an elongated tubular gas generator—that is for the most part arranged in the airbag 12, and a holding element 16 by means of which the airbag 12 and the gas generator 14 are fastened in the airbag module 10 and to a vehicle.

The airbag 12 shown here is a side-impact airbag having several inflatable chambers 17 that, in a generally known manner, are separated from each other by non-inflatable sections or seams. Essentially the airbag 12 consists of two layers of fabric that are sewed or woven together.

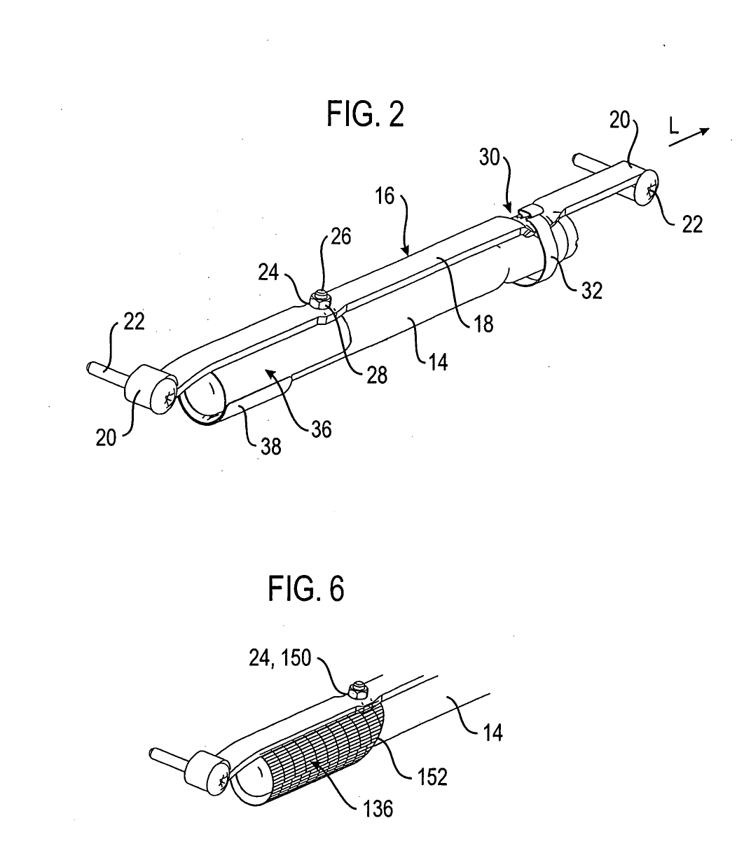

The holding element 16 has a rigid, elongated, preferably flat base 18. The base 18 is rod-shaped. A fastening section 20 is provided at each end of the base 18. For this purpose, the material of the base is rolled up to form an eyelet that extends perpendicular to a lengthwise direction L of the base 18 (see, for example, FIG. 2). The entire holding element 16 can be formed, for instance, from a flat steel bar.

The eyelets are configured so as to each accommodate a fastening means 22 that allows the holding element 16 to be fastened to a vehicle part with the fastening means 22 extending perpendicular to the lengthwise direction L and parallel to the flat top of the base 18. The airbag module 10 shown is fastened along a roof frame under an interior cladding of the vehicle.

The fastening means 22, for example, screws, can be inserted into the fastening section 20, as seen in the lengthwise direction L of the base 18, both from the right-hand side as well as from the left-hand side of the base 18. This has the advantage that the holding element 16 can be used for fastening an airbag module 10 on the driver's side as well as on the passenger's side of a vehicle.

The holding element 16 is essentially mirror-symmetrical relative to the lengthwise direction L.

The end sections of the base 18 are rolled up here in the same direction in order to form the fastening sections 20. However, the manner in which the end of the base 18 is rolled up in order to form the fastening section 20 is, of course, left up to the discretion of the person skilled in the art.

At about one-third of the length of the base 18, an opening 24 is provided that runs perpendicular to the top of the base 18 and that serves to fasten the gas generator 14 to the holding element 16. Projecting through the opening 24 is a fastening bolt 26 or another suitable fastening section that is joined to the gas generator 14, that projects radially therefrom and that is affixed to the holding element 16 by a nut 28.

Further, at a sufficient distance from the opening 24, the base 18 has an indentation 30 that serves to hold a clamp 32 which, in turn, secures the gas generator 14 in a second position on the holding element 16. The clamp 32 also surrounds an insertion opening of the airbag 12 and closes it so as to be gas-tight. The indentation 30 prevents the clamp 32 from moving in the lengthwise direction L of the holding element 16.

The holding element 16 is shown arranged outside of the airbag 12. However, it could also be situated at least partially inside the airbag 12.

The end of the gas generator 14 located in the airbag 12 has an outflow area 34 with various individual outflow openings that are each formed in the outer wall of the gas generator 14. The outflow openings in the outflow area 34 are largely arranged in an opposed manner so that the gas generator 14 is essentially thrust-neutral when all of the outflow openings of the outflow area 34 are exposed.

Before the gas generator 14 is activated, the outflow area 34 is surrounded by a gas baffle plate 36. In the example shown, the gas baffle plate 36 consists of a metal plate formed of a one-piece blank that can be spread out flat. The gas baffle plate 36 is bent in such a way that it surrounds the gas generator 14 in the form of a tube. Here, the end sections 38 are laid over each other so that the end sections 38 overlap, preferably by a few centimeters.

The tube thus formed serves to guide gas to various inflatable chambers of the airbag 12 (see FIG. 1).

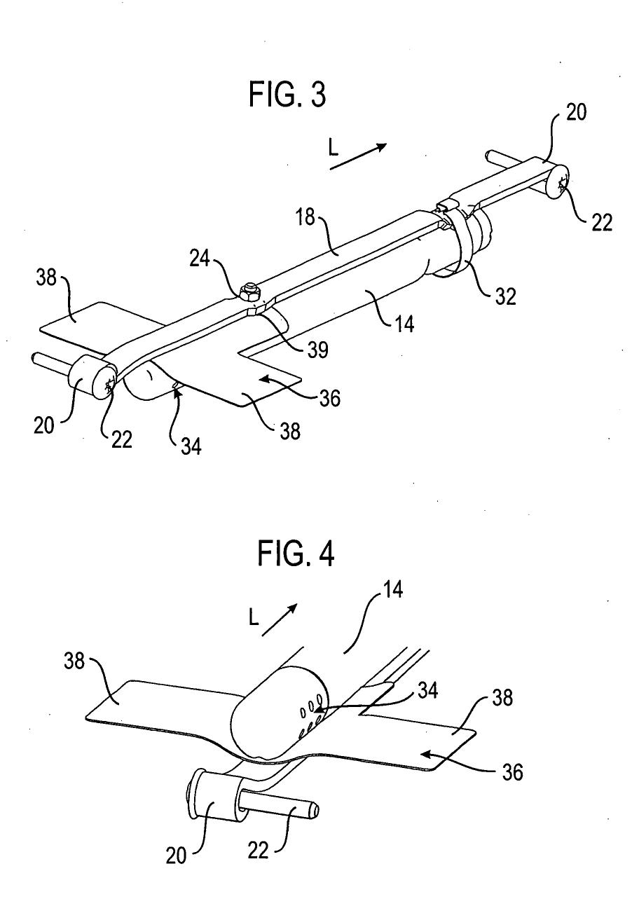

In a center region is situated between the end sections 38 that projects further in the lengthwise direction L than the end sections 38, an opening 39 (shown in FIG. 3) is provided in the gas baffle plate 36. The gas baffle plate 36 is arranged between the holding element 16 and the gas generator 14 in such a way that the opening 39 is flush with the opening 24 in the holding element 16, and the fastening bolt 26 of the gas generator 14 also projects through the opening 39, thus fastening the gas baffle plate 36 to the holding element 16.

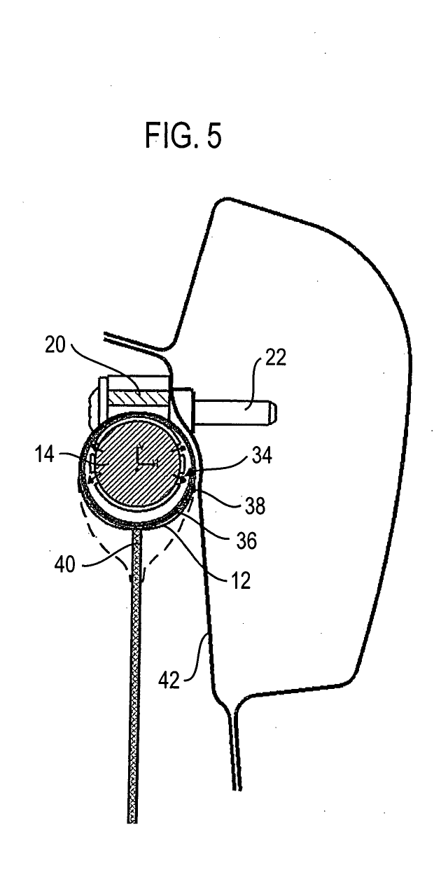

The airbag 12 has a partition 40 (FIGS. 1 and 5) that, in this example, also separates various inflatable chambers 17 from each other. The partition is, for example, a seam or a section in which the two fabric layers of the airbag 12 are woven directly together with each other. The partition 40 can be configured continuously or it can be divided into several short sections. In the area of the partition 40, the diameter of the airbag 12 is only negligibly larger than the tubular, rolled-up gas baffle plate 36.

As an alternative or in addition, as in the embodiment shown, in order to create the vehicle occupant restraint system, the airbag module 10 is installed in a vehicle in such a way that the gas baffle plate 36 is arranged in the immediate vicinity of a vehicle-fixed part 42, here a section of the car body. The outer of the end sections 38 can already be supported on the vehicle-fixed part 42, here the roof frame, or else can be installed with a small gap with respect to the vehicle-fixed part 42.

The gas baffle plate 36 fulfills the functions described below. In the case of a normal activation of the airbag module 10, the airbag module 10 is mounted in a vehicle as shown in FIG. 5. Here, the fastening means 22 reach through the fastening sections 20 of the holding element 16 and secure the airbag module 10 to a vehicle-fixed part (that does not have to be identical to the vehicle-fixed part 42 described above). If the airbag module 10 is activated in case of an accident, a sensor signal is sent to the gas generator 14, in response to which an igniter deflagrates a gas-generating compound inside the gas generator 14 (not shown). This results in a gas flow that leaves the gas generator 14 through the outflow area 34 (also see the arrows in FIG. 5). The gas baffle plate 36 deflects the gas flow by about 90° and divides it into two opposing partial flows, thus distributing the gas among various inflatable chambers 17 of the airbag 12. Moreover, the gas baffle plate 36 prevents the gas that is flowing out of the gas generator 14 from coming into contact with the fabric of the airbag 12 too soon.

The gas flow exerts a force that is oriented radially outwards on the gas baffle plate 36 and strives to spread the end sections 38 apart and to bend open the gas baffle plate 36.

During normal activation, the partition 40 of the airbag 12 prevents the gas baffle plate 36 from unrolling since the airbag 12 tightly surrounds the gas baffle plate and exerts a sufficient force against the gas flow.

As an alternative or in addition, the gas baffle plate 36 is supported on the vehicle-fixed part 42 so that the force of the air flow can be introduced into the vehicle and the gas baffle plate 36 is prevented from unrolling. In this case, the airbag 12 does not have to surround the gas baffle plate 36 so tightly, as is shown by the broken lines in FIG. 5.

The case is different when the airbag module 10 is not yet installed in the vehicle. Activation of the airbag module 10 in the uninstalled state is generally simulated in the so-called bonfire test. Here, the entire airbag module 10 is exposed for a prolonged period of time to an elevated ambient temperature of, for instance, 160° C. [320° F.]. The requirement is that the gas generator 14 has to ignite spontaneously and to burn in a controlled manner, during which the entire airbag module 10 should behave thrust-neutrally.

Under the conditions of such a bonfire test, the fabric of the airbag 12 will break down or soften. So when gas from the gas generator 14 comes out of the outflow area 34, the partition 40 of the airbag 12 cannot resist the force of the gas flow and the partition 40 no longer holds gas baffle plate 36 in the rolled-up state.

Moreover, since the gas baffle plate 36 is not situated close to the vehicle-fixed part 42 and consequently cannot be supported by it the latter, it will bend open (at least approximately) to form the state shown in FIGS. 3 and 4. As a result, the outflow openings of the outflow area 34, which had been covered until then, are uncovered and the thrust-neutrality of the gas generator 14 and thus of the entire airbag module 10 is established.

In contrast, when the airbag module is activated when it is installed in the vehicle, the gas baffle plate 36 fulfills its function of distributing the gas flow and of protecting the airbag fabric during the complete activation phase.

In a second embodiment, which is shown in FIG. 6, instead of the gas baffle plate 36, a flexible gas-guiding tube 136 made of fabric is provided that is pulled over the outflow area 34 of the gas generator 14 and that has a fastening opening 150 lying flush with the opening 24 for fastening the gas generator 14 to the holding element 16. The gas-guiding tube 136 is firmly joined to the holding element 16 via this fastening opening 150. The end of the gas-guiding tube 136 facing the gas generator 14 is beveled (reference numeral 152).

When the airbag module of this embodiment is subjected to a bonfire test outside of the vehicle, the material of the gas-guiding tube 136 breaks down and fails so that the outflow area 34 of the gas generator 14 is uncovered and the airbag module 10 becomes at least approximately thrust-neutral.

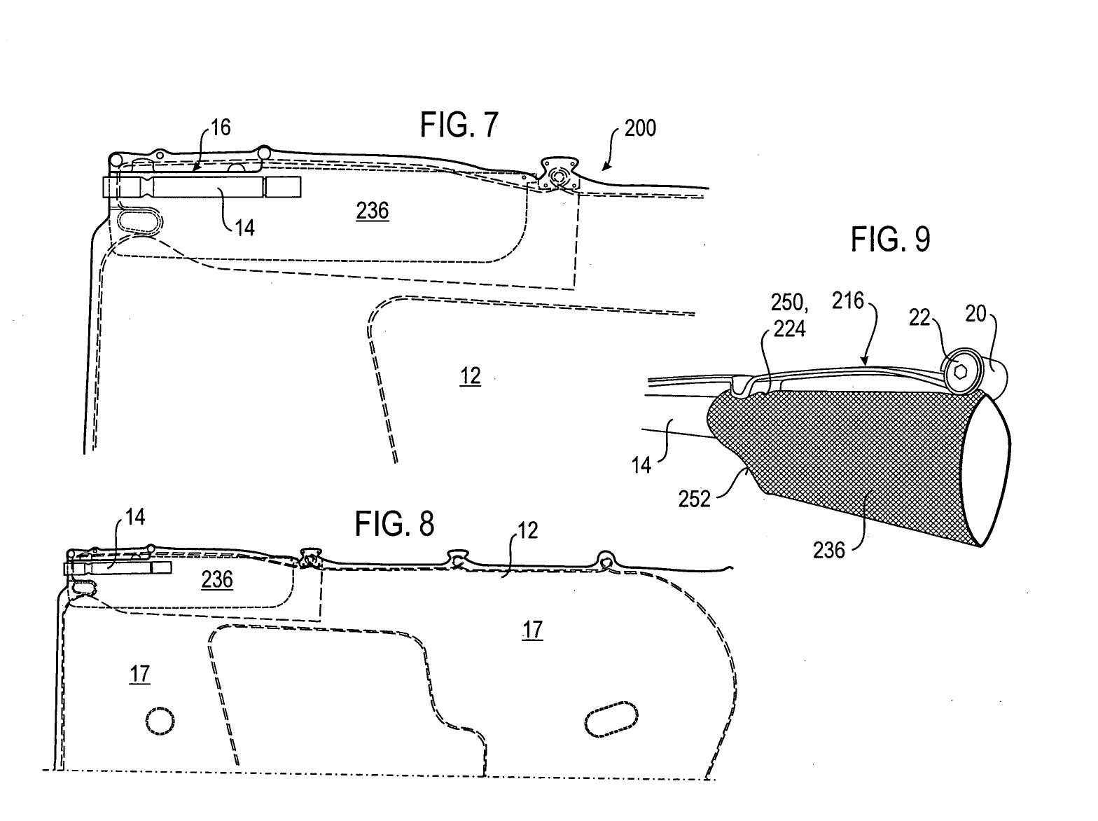

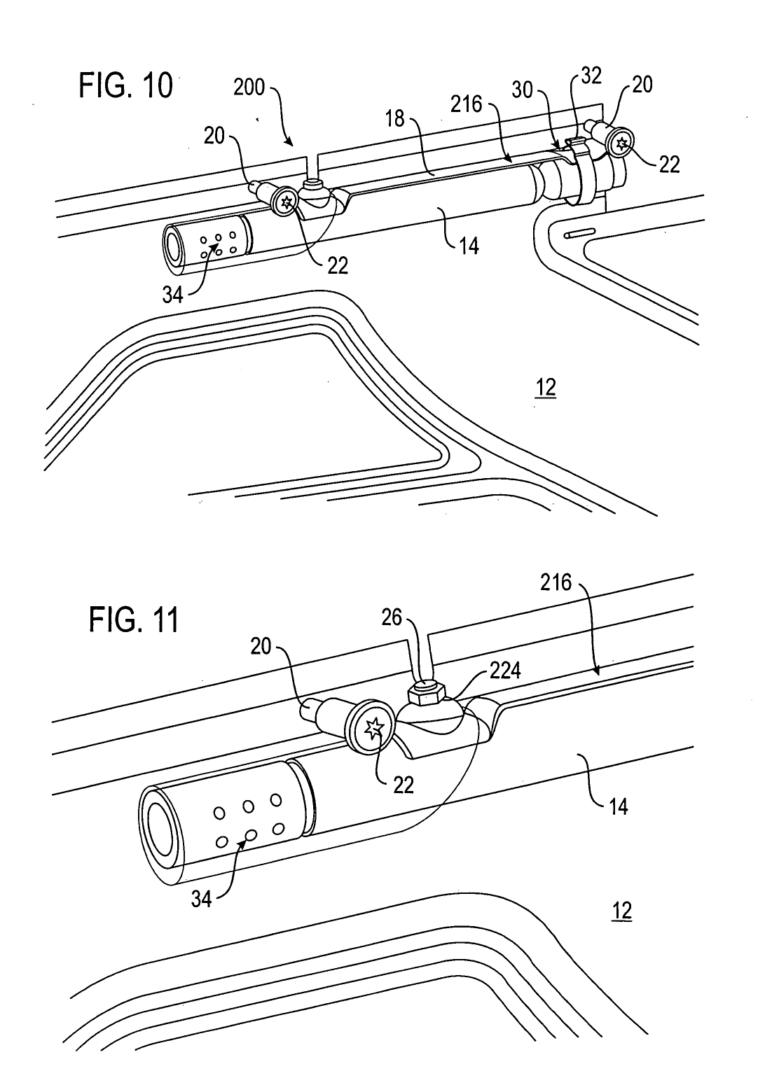

Another embodiment is described with respect to FIGS. 7 to 11.

The airbag module 200 shown there likewise comprises an airbag 12 with several inflatable chambers as well as a gas generator 14 in the form of an elongated tubular gas generator.

The gas generator 14 is largely arranged inside the airbag 12.

An elongated holding element 216, shown in greater detail in FIGS. 9 to 11, is joined to the gas generator 14 and likewise arranged in the airbag 12. Analogously to the first embodiment, the holding element 216 has an elongated base 18 and, at its ends, two sections that are bent to form fastening sections 20 through which fastening means 22 join the airbag module 200 to the vehicle.

An indentation 30 for securing the position of a clamp 32 is likewise provided.

Like in the first embodiment, in this case as well, the holding element 216 is configured essentially mirror-symmetrical to its lengthwise direction L.

Unlike the first embodiment, in the area of the opening 224 for fastening the gas generator 14, the shape of the holding element 216 is adapted to the shape of the outer wall of the gas generator 14. In the present example, this is done by creating one or more beads.

A gas-distributing tube 236 (see FIG. 9) that distributes the out-flowing gas among the inflatable chambers 17 of the airbag 12 is pulled over the outflow area 34 of the gas generator 14. The gas-distributing tube 236 has a fastening opening 250 that, in turn, is flush with the opening 224 for the fastening means of the gas generator 14. The fastening bolt 26 that projects radially from the gas generator 14 extends through the fastening opening 250 in the gas-distributing tube 236 as well as through the opening 224 in the holding element 216 so that the gas generator 14 as well as the gas-distributing tube 236 can be securely fastened to the holding element 216.

Analogously to the gas-distributing tube described in FIG. 6, the gas-distributing tube 236 is also provided with a bevel 252 at its end facing the gas generator 14.

Due to the adapted shape of the wall of the holding element 216 in the area of the opening 224, the gas-distributing tube 236—which is made, for example, of an airbag fabric—is held virtually gas-tight between the holding element 216 and the outer wall of the gas generator 14 so that no gas can escape from the airbag 12 at this place.

The holding element 216 could also be arranged outside of the airbag 12.

The sealing effect brought about by the shape adaptation of the holding element 216 in the area of the opening 224 could also be utilized to fasten the airbag 12 to the holding element 216 in a gas-tight manner.

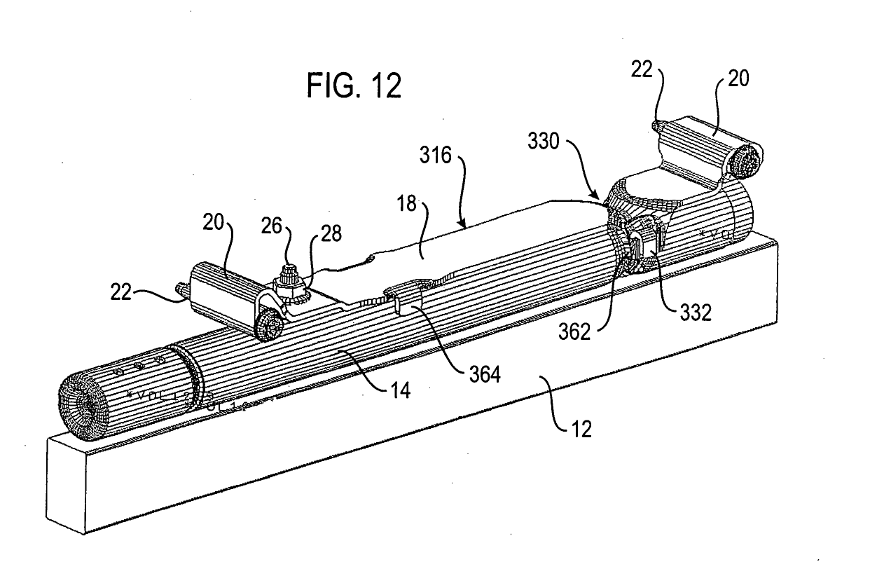

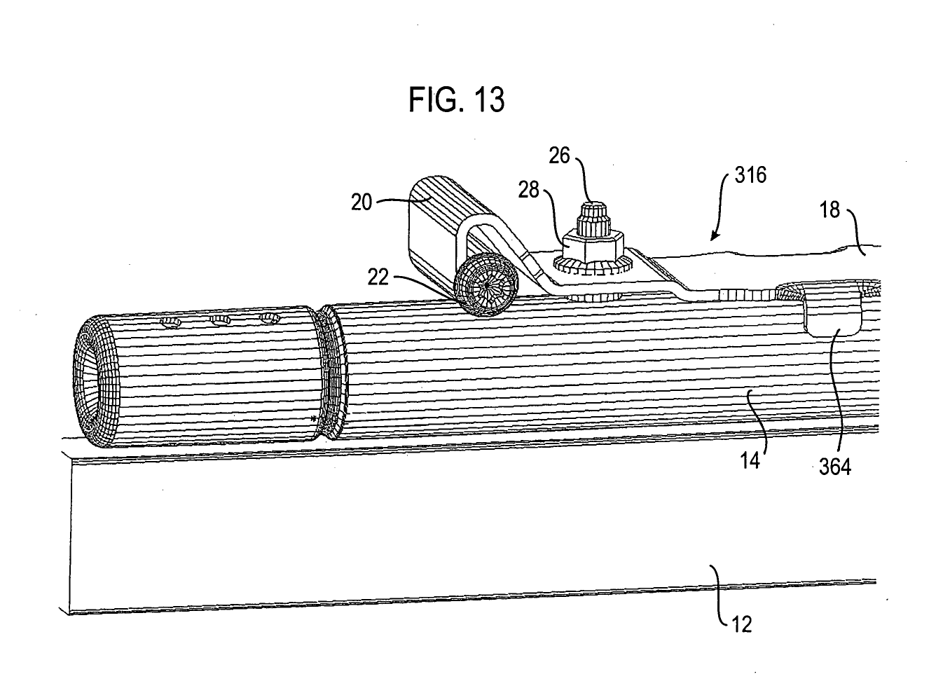

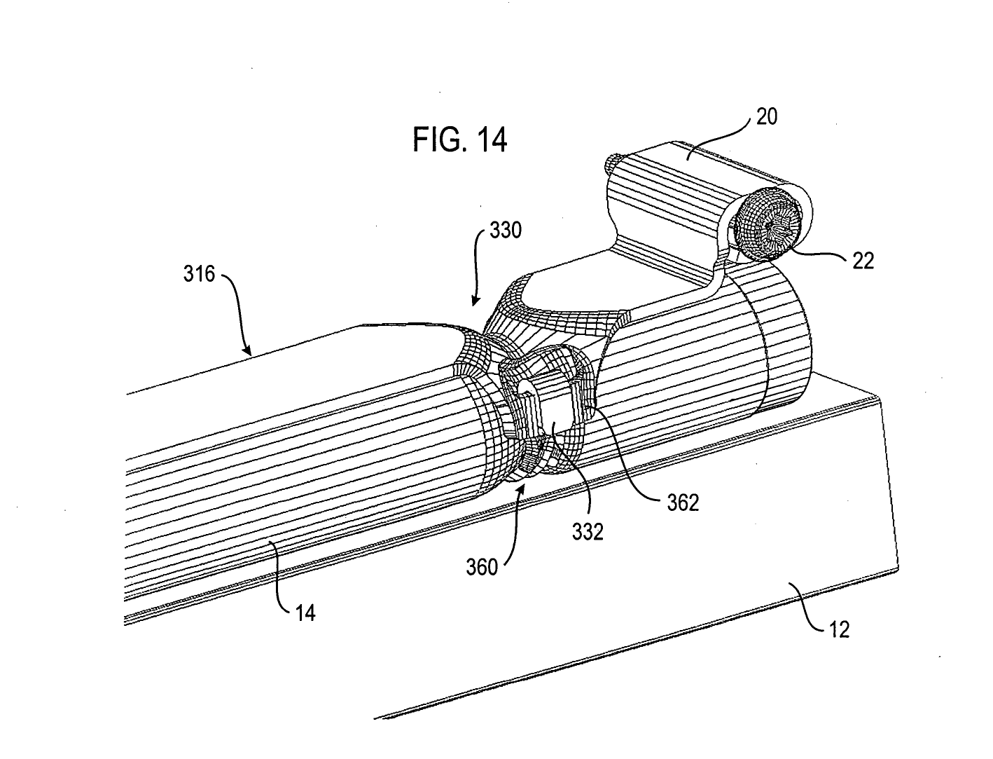

FIGS. 12 to 15 show an embodiment in which the holding element 316 is shorter than the gas generator 14. In contrast to the airbag module 10 shown in FIG. 1, in which the section of the holding element 16 on the igniter side projects with the fastening section 20 beyond the gas generator 14, here, the fastening section 20 of the holding element 316 ends with the end of the gas generator 14.

Here, the second end of the holding element 316 with the second fastening section 20 is only slightly behind the opening 24 through which the fastening bolt 26 of the gas generator 14 protrudes.

Both fastening sections 20 are bent away from the gas generator 14 and rolled up in opposite directions.

An indentation 330 of the holding element 316 engages in a circumferential indentation 360 of the gas generator 14. In the area of the indentation 330, two fastening means 362 in the form of tabs for a holding bracket 332 that partially surrounds the gas generator 14 are created on the base 18 of the holding element 316 symmetrically to the lengthwise direction L. The holding bracket 332, which assumes the function of the clamp 32 in this embodiment, engages in the tabs on both sides in order to secure the gas generator 14 and, if applicable, the inflation opening of the airbag 12 (not shown here), to the holding element 316.

The holding bracket 332 is initially U-shaped and is pushed with its ends through the tabs. Subsequently, the ends are bent over.

Two hook-shaped pre-fastening projections 364 are formed on the holding element 316 between the indentation 330 and the opening 24, each of these projections extending perpendicular to the lengthwise direction L of the holding element 316 and defining the position of the gas generator 14 with respect to the holding element 316, at least temporarily.

The individual features of the presented embodiments can be combined with each other or switched with each other at the discretion of the person skilled in the art.

The embodiment of the gas baffle plate 36 presented here can also be used completely independently of the use of the described holding element 16. Such a configuration lends itself wherever a gas generator or an airbag module is supposed to have thrust-neutrality when it is not installed in the vehicle, while during normal actuation, some of the outflow openings are covered and a gas-guiding function is to be achieved. By the same token, the use is not limited to airbag modules arranged underneath an interior cladding.

Moreover, the use of a gas-distributing tube of the embodiment just described as well as the sealing of the gas-distributing tube by means of a holding element whose shape is adapted to the gas generator is independent of the specifically described form of the holding element 216.

By the same token, of course, the holding element 16, 216, 316 can be used in any other suitable airbag modules.

1. A holding element that fastens a gas generator (14) in an airbag module (10; 200), comprising:
a rigid, elongated base (18) and
at least one fastening section (20) that allows the holding element (16; 216) to be fastened to a vehicle-fixed part perpendicular to the lengthwise direction (L) of the base (18).

2. The holding element according to claim 1, wherein the fastening section (20), seen in the lengthwise direction (L) of the base (18), can be fitted with fastening means (22) from opposite sides of the base (18).

3. The holding element according to claim 1, wherein the holding element (16; 216) is configured so as to be essentially mirror-symmetrical relative to the lengthwise direction (L) of the base (18).

4. The holding element according to claim 1, wherein the fastening section (20) is formed in that an end section of the base (18) is bent to form an eyelet.

5. The holding element according to claim 1, wherein two fastening sections (20) are provided.

6. The holding element according to claim 1, wherein the base (18) has an indentation (30) for holding a clamp (32) to secure an airbag (12) to the holding element (16; 216).

7. The holding element according to any claim 1, wherein at least one fastening means (362) for a holding bracket (332) for partially surrounding a gas generator is provided on the base (18).

8. The holding element according to claim 1, wherein an opening (24; 224) for fastening a gas generator (14) is provided in the base (18).

9. An airbag module comprising an airbag (12) and an elongated gas generator (14) that is arranged at least partially inside the airbag (12).

10. The airbag module according to claim 9, wherein a holding element (16; 216) is provided with a rigid, elongated base (18) and at least one fastening section (20) that allows the holding element (16; 216) to be fastened to a vehicle-fixed part perpendicular to the lengthwise direction (L) of the base (18).

11. The airbag module according to claim 9, wherein the gas generator (14) is surrounded at least in sections by a gas baffle plate (36).

12. The airbag module according to claim 11, wherein the gas baffle plate (36) is formed of one single blank that can be spread out flat.

13. The airbag module according to claim 11, wherein two end sections (38) of the gas baffle plate (36) overlap.

14. The airbag module according to claim 11, wherein, when the airbag module (10) is in the installed state in the vehicle, the gas baffle plate (36) is arranged in the immediate vicinity of a vehicle-fixed part (42) in such a way that the gas baffle plate (36) is supported on the vehicle-fixed part (42) when the airbag module (10) is activated.

15. The airbag module according to claim 11, wherein the airbag (12) can have a partition (40) whose dimensions are selected in such a way that the gas baffle plate (36) is supported on the partition (40) during normal activation of the airbag module (10).

16. The airbag module according to claim 11, wherein, during an activation of the airbag module (10) when it is not installed in a vehicle, the pressure of the gas flowing from the gas generator (14) pushes the overlapping end sections (38) away from each other.

17. The airbag module according to claim 16, wherein the airbag module (10) is activated under the conditions of a bonfire test.

18. The airbag module according to claim 10, wherein a gas-distributing tube (236) that surrounds the gas generator (14) is provided with a fastening opening (250) via which the gas-distributing tube (236) is fastened to the holding element (216), said holding element (216) being adapted in the region of the fastening opening (250) to the curvature of the outer wall of the gas generator (14), so that the gas-distributing tube (236) is sealed off vis-à-vis the holding element (216).

19. The airbag module according to claim 18, wherein an opening (224) for fastening a gas generator (14) is provided in the base (18) of the holding element (216) and the gas-distributing tube (236) is fastened by the opening (224) to the holding element (216).

20. The airbag module according to claim 19, wherein the holding element (216) has at least one bead running around the opening (24) for fastening the gas generator (14).

21. The airbag module according to claim 19, wherein the gas generator (14) has a radially projecting fastening bolt (26) that protrudes through the fastening opening (250) in the gas-distributing tube (236) and through the opening (224) for fastening the gas generator (14) in the holding element (216).
